(19) United States
(12) Patent Application Publication
(10) Pub. No.: US 2024/0365863 A1
(43) Pub. Date: Nov. 7, 2024

(54) A CONSUMABLE FOR USE WITH AN AEROSOL PROVISION DEVICE

(71) Applicant: NICOVENTURES TRADING LIMITED, London (GB)

(72) Inventor: John RICHARDSON, London (GB)

(21) Appl. No.: 18/681,115

(22) PCT Filed: Aug. 4, 2022
(86) PCT No.: PCT/EP2022/072001

§ 371 Date: Feb. 5, 2024

(51) Int. Cl. A24F 40/42; A24F 40/20; A24F 40/30; A24F 40/465; H05B 6/10

(52) U.S. Cl. CPC A24F 40/42; A24F 40/20; A24F 40/30; A24F 40/465; H05B 6/108

(57) ABSTRACT

A consumable suitable for use with a non-combustible aerosol provision system includes a support having a support surface, aerosol generating material, and a cover including a cover surface. The cover is configured to overlie a covered portion of the support surface and at least one discrete portion of aerosol generating material is supported on the covered portion of the support surface. The covered portion of the support surface and the cover surface are configured to include one or more contact zones, in which in each contact zone, a part of the covered portion of the support surface and a part of the cover surface are in direct or indirect contact with each other.

### RELATED APPLICATIONS

The present application is a National Phase entry of PCT Application No. PCT/EP2022/072001 filed Aug. 4, 2022, which claims priority to GB Application No. 2111258.6 filed Aug. 4, 2021, each of which is hereby incorporated by reference in their entirety.

### TECHNICAL FIELD

This disclosure relates to the field of non-combustible aerosol-provision systems, in particular to consumables for use with an aerosol provision device, an aerosol provision system including a consumable and an aerosol provision device, and a method of generating aerosol from a consumable.

### BACKGROUND

Smoking articles such as cigarettes, cigars and the like burn tobacco during use to create tobacco smoke. Alternatives to these types of articles release an inhalable aerosol or vapor by releasing compounds from a substrate material by heating without burning. These may be referred to as non-combustible smoking articles, aerosol generating assemblies, or aerosol provision devices.

One example of such a product is a heating device which release compounds by heating, but not burning, an aerosolizable material which may be referred to as a solid aerosol-generating material. This solid aerosol-generating material may, in some cases, contain a tobacco material. The heating volatilizes at least one component of the material, typically forming an inhalable aerosol. These products may be referred to as heat-not-burn devices, tobacco heating devices or tobacco heating products. Various different arrangements for volatilizing at least one component of the solid aerosol-generating material are known.

As another example, there are hybrid devices. These hybrid devices contain a liquid source (which may or may not contain nicotine) which is vaporized by heating to produce an inhalable vapor or aerosol. The device additionally contains a solid aerosol-generating material (which may or may not contain a tobacco material) and components of this material are entrained in the inhalable vapor or aerosol to produce the inhaled medium.

### SUMMARY

According to a first aspect of the present disclosure there is provided a consumable suitable for use with a non-combustible aerosol provision system, in which the consumable comprises a support, aerosol generating material, and a cover, in which the support comprises a support surface having a covered portion, the cover comprises a cover surface, the cover is configured to overlie the covered portion of the support surface, at least one discrete portion of aerosol generating material is supported on the covered portion of the support surface, each discrete portion of aerosol generating material supported on the covered portion of the support surface is supported at a portion location, one or both of the covered portion of the support surface and the cover surface are three dimensionally configured, the covered portion of the support surface and the cover surface are so configured that at each portion location the cover surface is sufficiently distanced from the covered portion of the support surface that there is no contact between at least part of the discreet portion of aerosol generating material at that portion location and the cover surface, the covered portion of the support surface and the cover surface are configured to include one or more contact zones, and in which in each contact zone a part of the covered portion of the support surface and a part of the cover surface are in direct or indirect contact with each other.

According to a second aspect of the present disclosure there is provided an aerosol provision device for use with a consumable according to the first aspect of the present disclosure, in which the device comprises an aerosol generator configured to heat at least a portion of the aerosol generating material supported on the consumable.

According to a third aspect of the present disclosure there is provided an aerosol provision system comprising an aerosol provision device and a consumable manufactured by a method according to the first aspect of the present disclosure.

According to a fourth aspect of the present disclosure there is provided a method of generating aerosol from a consumable according to the first aspect of the present disclosure using an aerosol-generating device with at least one aerosol generator disposed to heat, but not burn, the consumable in use; wherein at least one aerosol generator is a resistive heater element or a magnetic field generator and a susceptor.

Further features and advantages of the present disclosure will become apparent from the following description of embodiments of the disclosure given by way of example and with reference to the accompanying drawings.

### DRAWINGS

FIG. 1 shows a schematic view of an embodiment of an aerosol provision device;

FIG. 2 shows a first embodiment of a consumable according to the present disclosure;

FIG. 3 shows a section of the consumable of FIG. 2 along section line A-A′;

FIG. 4 shows a second embodiment of a consumable according to the present disclosure;

FIG. 5 shows a third embodiment of a consumable according to the present disclosure during manufacture;

FIG. 6 shows a perspective view of the third embodiment of a consumable according to the present disclosure;

FIG. 7 shows a section of the consumable of FIG. 6 along section line B-B′;

FIG. 8 shows a section of a fourth embodiment of a consumable according to the present disclosure; and

FIG. 9 shows a fifth embodiment of a consumable according to the present disclosure during manufacture.

### DETAILED DESCRIPTION

The consumable of the present description may be alternatively referred to as an article.

In some embodiments, the consumable comprises aerosol-generating material. The consumable may comprise an aerosol-generating material storage area, an aerosol-generating material transfer component, an aerosol generator, an aerosol generation area, a housing, a wrapper, an aerosol-modifying agent, one or more active constituents, one or more flavors, one or more aerosol-former materials, and/or one or more other functional materials.

The apparatus for heating the aerosol-generating material with which the consumable is to be used is a part of a non-combustible aerosol provision system. Non-combustible aerosol provision systems release compounds from an aerosol-generating material without combusting the aerosol-generating material, such as electronic cigarettes, tobacco heating products, and hybrid systems to generate aerosol using a combination of aerosol-generating materials.

According to the present disclosure, a “non-combustible” aerosol provision system is one where a constituent aerosol-generating material of the aerosol provision system (or component thereof) is not combusted or burned in order to facilitate delivery of substance to be delivered to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the non-combustible aerosol provision system, such as a non-combustible aerosol provision device may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

According to a first aspect of the present disclosure there is provided a consumable for use with an apparatus for heating an aerosol generating material to volatilize at least one component of the aerosol generating material, in which the consumable comprises a support, aerosol generating material, and a cover, in which
the support comprises a support surface having a covered portion,
the cover comprises a cover surface,
the cover is configured to overlie the covered portion of the support surface,
at least one discrete portion of aerosol generating material is supported on the covered portion of the support surface,
each discrete portion of aerosol generating material supported on the covered portion of the support surface is supported at a portion location,
one or both of the covered portion of the support surface and the cover surface are three dimensionally configured,
the covered portion of the support surface and the cover surface are so configured that at each portion location the cover surface is sufficiently distanced from the covered portion of the support surface that there is no contact between at least part of the discreet portion of aerosol generating material at that portion location and the cover surface,
the covered portion of the support surface and the cover surface are configured to include one or more contact zones, and
in which in each contact zone a part of the covered portion of the support surface and a part of the cover surface are in direct or indirect contact with each other.

According to an embodiment of the above embodiment the aerosol generating material is an aerosol generating film.

In an embodiment of any of the above embodiments a plurality of discrete portions of aerosol generating material are supported on the covered portion of the support surface.

In an embodiment of any of the above embodiments the part of the covered portion of the support surface and the part of the cover surface in the contact zone are in direct contact with each other when they are touching each other.

In an embodiment of any of the above embodiments the part of the covered portion of the support surface and the part of the cover surface in the contact zone are in indirect contact with each other when (i) there is an intermediate element or substance between the part of the covered portion of the support surface and the part of the cover surface, and (ii) both of the part of the covered portion of the support surface and the part of the cover surface are touching/in direct contact with the intermediate element or substance. Air or other gaseous substances are not, for the purposes of determining whether there is indirect contact between the part of the covered portion of the support surface and the part of the cover surface, considered to be an intermediate element or substance.

In an embodiment of the above embodiment there are two or more (n) intermediate elements E₁ to Eₙ, intermediate element E₁ touches the part of the covered portion of the support surface, intermediate element Eₙ touches the part of the cover surface, and where n is greater than or equal to 3 each intermediate element Ex between the intermediate elements E1 and Eₙ touches both intermediate elements E₍ₓ₋₁₎ and E₍ₓ₊₁₎, or where n is equal to 2 intermediate element E₁ touches intermediate element E₂.

Alternatively expressed, where there are one or more intermediate elements between the part of the covered portion of the support surface and the part of the cover surface in the contact zone those parts of the support surface and cover surface are in indirect contact when there is no air/gas filled gap between those surfaces.

In an embodiment of any of the above embodiments at least one intermediate element comprises one of a non-gaseous material, a solid material, a gel, a paste, a shim, a seal, a gasket, an adhesive, a caulk, or a sealing compound.

The support may be of a material suitable to form a substrate. The support may, for example, be or comprise paper, card, paperboard, cardboard, reconstituted material, a plastics material, a ceramic material, a composite material, glass, a metal, or a metal alloy.

In an embodiment of any of the above embodiments the support comprises a plastics material which can withstand the temperatures typically encountered in a non-combustible aerosol provision device. In some embodiments the support comprises polyether ether ketone (PEEK). Such embodiments have the advantage that the support may be reused, and that the consumable is less affected by any condensation in the non-combustible aerosol provision device than consumables that comprise a support which includes use of a sorbent material for structural purposes.

The cover may be of a material suitable to form a substrate. The cover may, for example, be or comprise paper, card, paperboard, cardboard, reconstituted material, a plastics material, a ceramic material, a composite material, glass, a metal, or a metal alloy.

In an embodiment of any of the above embodiments the cover comprises a plastics material which can withstand the temperatures typically encountered in a non-combustible aerosol provision device. In some embodiments the cover comprises polyether ether ketone (PEEK). Such embodiments have the advantage that the cover may be reused, and that the consumable is less affected by any condensation in the non-combustible aerosol provision device than a cover which includes use of a sorbent material.

In an embodiment of any of the above embodiments, the covered portion of the support surface and the cover surface are so configured that they define at least one passage and at least one passage includes at least one portion location.

This has the advantage that the discrete portions of the aerosol generating material located at the portion locations within a passage are protected from contamination by contact with users of the consumable or other objects that may carry chemical or biological materials that could contaminate the aerosol generating material. Those discrete portions of aerosol generating material are also protected from physical damage or abrasion resultant from impact with parts of the aerosol generating device or other objects, or mishandling by a user of the consumable.

In an embodiment of any of the above embodiments, each portion location is located in a passage.

In an embodiment of any of the above embodiments the or each passage is so configured that fluid at or near atmospheric pressure, for example an aerosol, may flow along the passage in sufficient volume that when the consumable is being used in connection with an aerosol provision device the user of the aerosol provision device may draw at least a predetermined minimum flow rate of fluid through the or each passage. In some embodiments the predetermined minimum flow rate is in the range of 20 ml/s to 100 ml/s, in the range of 20 ml/s to 80 ml/s, in the range of 20 ml/s to 60 ml/s, in the range of 30 ml/s to 60 ml/s, around 30 ml/s, around 40 ml/s, around 50 ml/s or around 60 ml/s.

In an embodiment of any of the above embodiments, the cover surface has a perimeter that extends around the edge of the cover surface, and a first end of at least one passage is open and partially defined by a part of the perimeter of the cover surface. In the context of the present disclosure, open is to be understood to mean that fluid may pass through the end into or out of the passage.

In an embodiment of any of the above embodiments, a second end of at least one passage is open and partially defined by a part of the perimeter of the cover surface.

In an embodiment of any of the above embodiments, a first end of at least one passage is open and defined by an aperture extending through one of the covered portion of the support surface or the cover surface.

In an embodiment of any of the above embodiments, a second end of at least one passage is open and defined by an aperture extending through one of the covered portion of the support surface or the cover surface.

In an embodiment of any of the above embodiments, at least one end of at least one passage is open and opens into another passage. In such an embodiment the at least one end of the passage is defined by a wall of the passage into which it opens. In such embodiments two or more passages may connect and fluid may flow through a plurality of passages in the course of that fluid's movement through the consumable of the present disclosure when the consumable is in use.

In an embodiment of any of the above embodiments, at least one passage has a non-uniform cross-section along the length of the passage. In some embodiments the cross-section may be non-uniform for fluid flow control reasons, for example to speed up or slow down the flow of air, aerosol or a mixture of air and aerosol along the passage.

In an embodiment of any of the above embodiments, there are two or more passages and two of the passages are separated from each other by one contact zone. In some embodiments of this embodiment the separation of the passages a lateral separation, that is the passages lie side by side and the contact zone is at least part of the material separating the passages.

In an embodiment of any of the above embodiments, each of the passages is separated from the other passages by one or more contact zones.

In an embodiment of any of the above embodiments, there are two or more passages and at least two of the passages are approximately parallel to each other. In some embodiments at least two of the approximately parallel passages are adjacent to each other.

In an embodiment of any of the above embodiments, at least one passage is approximately linear between the first and second ends of that passage. In some embodiments each of the passages are approximately linear between their first and second ends.

In an embodiment of any of the above embodiments, the covered portion of the support surface and the cover surface are so configured that at at least one portion location the support surface and the cover surface define one or more chambers, and at least one of the chambers is so configured that in that or those chambers there is no contact between the discreet portion of aerosol generating material and the cover surface. In some embodiments a chamber is, in a particular direction, of a larger dimension than the equivalent dimension in that direction in the or each passage that opens into that chamber.

In an embodiment of any of the above embodiments, at least one of the chambers is in fluid contact with at least one of the passages.

In an embodiment of any of the above embodiments, at least one end of at least one passage opens into one of the chambers.

In an embodiment of any of the above embodiments, at least one of the contact zones is so configured that the part of the covered portion of the support surface and the part of the cover surface in direct or indirect contact with each other in that or those contact zones are fixed to each other using a fixing means.

In an embodiment of any of the above embodiments, the fixing means is an adhesive.

In an embodiment of any of the above embodiments, the fixing means is a melted and subsequently solidified part of one or both of the support surface and the cover surface.

In an embodiment of any of the above embodiments, the fixing means is a physical connection means mounted on or extending through the contact zone.

In an embodiment of any of the above embodiments, at least one of the contact zones is so configured that the part of the covered portion of the support surface and the part of the cover surface abut but are not fixed to each other.

In an embodiment of any of the above embodiments, the support and the cover are held in a fixed relationship relative to each other by at least one wrapping element extending around at least a part of the support and the cover.

In an embodiment of any of the above embodiments, one of the covered portion of the support surface and the cover surface is substantially flat.

In an embodiment of any of the above embodiments, the three dimensional configuration of one or both of the covered portion of the support surface and the cover surface is the result of molding one or both of the covered portion of the support and the cover. In some embodiments the molding occurs during the formation of one or both of the covered portion of the support and the cover. In other embodiments, one or both of the covered portion of the support and the cover are molded after formation of the covered portion of the support and/or the cover, for example by plastic deformation of the covered portion of the support and/or the cover.

In an embodiment of any of the above embodiments, the three dimensional configuration of one or both of the covered portion of the support surface and the cover surface is the result of embossing or debossing one or both of the covered portion of the support and the cover.

In an embodiment of any of the above embodiments, the three dimensional configuration of one or both of the support surface and the cover surface is the result of folding one or both of the covered portion of the support and the cover.

In an embodiment of any of the above embodiments, one or both of the support and the cover is a sheet material.

In an embodiment of any of the above embodiments, the support surface further comprises a second portion, the cover further compromises a second cover surface, the support and support surface are so configured that the support can be folded into a folded configuration, and the second portion of the support surface overlies the second cover surface when the support is in the folded configuration. In some embodiments the support and support surface at least partially wrap around the cover when the support is in the folded configuration.

In an embodiment of the above embodiment, at least one discrete portion of aerosol generating material is supported on the second portion of the support surface,
each discrete portion of aerosol generating material supported on the second portion of the support surface is supported at a second portion location,
one or both of the second portion of the support surface and the second cover surface are three dimensionally configured,
the second portion of the support surface and the second cover surface are so configured that at each second portion location the second cover surface is sufficiently distanced from the second portion of the support surface that there is no contact between at least part of the discreet portion of aerosol generating material at that second portion location and the second cover surface,
the second portion of the support surface and the second cover surface are configured to include one or more second contact zones in which a part of the second portion of the support surface and a part of the second cover surface are in direct or indirect contact with each other.

In an embodiment of any of the above embodiments a plurality of discrete portions of aerosol generating material are supported on the second portion of the support surface.

In an embodiment of any of the above embodiments, the second portion of the support surface and the second cover surface are so configured that they define at least one second passage, and at least one second passage includes at least one second portion location.

In an embodiment of any of the above embodiments, each second portion location is located in a second passage.

In an embodiment of any of the above embodiments, the second cover surface has a perimeter that extends around the edge of the second cover surface, and a first end of at least one second passage is open and partially defined by a part of the perimeter of the second cover surface.

In an embodiment of any of the above embodiments, a second end of the at least one second passage is open and partially defined by a part of the perimeter of the second cover surface.

In an embodiment of any of the above embodiments, a first end of at least one second passage is open and defined by an aperture extending through one of the second portion of the support surface or the second cover surface.

In an embodiment of any of the above embodiments, a second end of at least one second passage is open and defined by an aperture extending through one of the covered portion of the support surface or the cover surface.

In an embodiment of any of the above embodiments, at least one end of at least one second passage is open and opens into another second passage. In such an embodiment the at least one end of the second passage is defined by a wall of the second passage into which it opens.

In an embodiment of any of the above embodiments at least one end of at least one first passage is open and opens into a second passage.

In an embodiment of any of the above embodiments at least one end of at least one second passage is open and opens into a first passage.

In an embodiment of any of the above embodiments, at least one second passage has a non-uniform cross-section along the length of the second passage. In some embodiments the cross-section may be non-uniform for fluid flow control reasons, for example to speed up or slow down the flow of air, aerosol or a mixture of air and aerosol along the second passage.

In an embodiment of any of the above embodiments, there are two or more second passages and two of the second passages are separated from each other by one second contact zone.

In an embodiment of any of the above embodiments, each of the second passages is separated from other second passages by one or more second contact zones. In some embodiments of this embodiment the separation of the second passages is a lateral separation, that is the passages lie side by side and the second contact zone is at least part of the material separating the second passages.

In an embodiment of any of the above embodiments, there are two or more second passages and at least two of the second passages are approximately parallel to each other. In some embodiments at least two of the approximately parallel second passages are adjacent to each other.

In an embodiment of any of the above embodiments, at least one second passage is approximately linear between the first and second ends of that second passage.

In an embodiment of any of the above embodiments, the second portion of the support surface and the second cover surface are so configured that at at least one second portion location the support surface and the second cover surface define one or more chambers, and at least one of the chambers is so configured that in that or those chambers there is no contact between the discreet portion of aerosol generating material and the second cover surface.

In an embodiment of any of the above embodiments, at least one of the chambers is in fluid contact with at least one of the second passages.

In an embodiment of any of the above embodiments, at least one end of at least one second passage opens into one of the chambers.

In an embodiment of any of the above embodiments, at least one of the second contact zones is so configured that the part of the second portion of the support surface and the part of the second cover surface in direct or indirect contact with each other in that or those contact zones are fixed to each other using a fixing means.

In an embodiment of any of the above embodiments, the fixing means is an adhesive.

In an embodiment of any of the above embodiments, the fixing means is a melted and subsequently solidified part of one or both of the support surface and the second cover surface.

In an embodiment of any of the above embodiments, the fixing means is a physical connection means mounted on or extending through the second contact zone.

In an embodiment of any of the above embodiments, at least one of the second contact zones is so configured that the support surface and the second cover surface abut but are not fixed to each other.

In an embodiment of any of the above embodiments, one of the second portion of the support surface and the second cover surface is substantially flat.

In an embodiment of any of the above embodiments both the covered portion and the second portion of the support surface are substantially flat, and the cover is a sheet material substantially even thickness which is three dimensionally configured so that the cover surface and the second cover surfaces are approximately parallel to each other.

In an embodiment of any of the above embodiments, the three dimensional configuration of one or both of the second portion of the support surface and the second cover surface is the result of molding one or both of the second portion of the support and the cover. In some embodiments the molding occurs during the formation of one or both of the second portion of the support and the cover. In other embodiments, one or both of the second portion of the support and the cover are molded after formation of the second portion of the support and/or the cover, for example by plastic deformation of the second portion of the support and/or the cover.

In an embodiment of any of the above embodiments, the three dimensional configuration of one or both of the second portion of the support surface and the second cover surface is the result of embossing or debossing one or both of the support and the cover.

In an embodiment of any of the above embodiments, the three dimensional configuration of one or both of the second portion of the support surface and the second cover surface is the result of folding one or both of the support and the cover.

In an embodiment of any of the above embodiments, the support comprises a latching means for retaining the support in the folded configuration.

In an embodiment of any of the above embodiments, the support comprises at least one susceptor.

In an embodiment of any of the above embodiments, the cover comprises at least one susceptor.

In an embodiment of any of the above embodiments, the susceptor is a metal or a metal alloy.

In an embodiment of any of the above embodiments, the susceptor is a metallic foil or metallic film. In some embodiments the susceptor is aluminium foil.

In an embodiment of any of the above embodiments, one or both of the covered portion of the support surface and the second portion of the support surface comprise a susceptor.

In an embodiment of any of the above embodiments, the aerosol generating material is an aerosolizable gel.

In an embodiment of any of the above embodiments, there are at least two discrete portions of aerosol generating material, and at least two discrete portions of aerosol generating material have different compositions relative to each other. This has the advantage that a user of the consumable manufactured according to the present disclosure may have different experiences when different discrete portions of aerosol generating material on the consumable are aerosolized. This may make the use of the consumable more enjoyable and/or more interesting than use of a consumable that has aerosol generating material of only one composition.

A susceptor is a material that is heatable by penetration with a varying magnetic field, such as an alternating magnetic field. The susceptor may be an electrically-conductive material, so that penetration thereof with a varying magnetic field causes induction heating of the susceptor by resistive heating as a result of electric eddy currents. The susceptor may be magnetic material, so that penetration thereof with a varying magnetic field causes magnetic hysteresis heating of the susceptor. The susceptor may be both electrically-conductive and magnetic, so that the susceptor is heatable by both heating mechanisms. The device that is configured to generate the varying magnetic field is referred to as a magnetic field generator.

The susceptor may comprise a metal or metal alloy. The susceptor may comprise a ferromagnetic metal such as iron or an iron alloy such as steel or an iron nickel alloy. Some example ferromagnetic metals are a 400 series stainless steel such as grade 410 stainless steel, or grade 420 stainless steel, or grade 430 stainless steel, or stainless steel of similar grades. Alternatively, the susceptor may comprise a suitable non-magnetic, in particular paramagnetic, conductive material, such as aluminium. In a paramagnetic conductive material inductive heating occurs solely by resistive heating due to eddy currents. Alternatively, the susceptor may comprise a non-conductive ferrimagnetic material, such as a non-conductive ferrimagnetic ceramic. In that case, heat is only generated by hysteresis losses. The susceptor may comprise a commercial alloy like Phytherm 230 (with a composition (in % by weight=wt %) with 50 wt % Ni, 10 wt % Cr and the rest Fe) or Phytherm 260 (with a composition with 50 wt % Ni, 9 wt % Cr and the rest Fe).

The susceptor may in some embodiments of any of the above embodiments be a metal foil or film, optionally an aluminium foil or film or a ferrous foil or film. Alternatively, the susceptor may in some embodiments of any of the above embodiments be any conductor that could be sprayed or vapor deposited on a material that forms the support. Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise one or more active substances and/or flavors, one or more aerosol-former materials, and optionally one or more other functional material.

The aerosol-generating material may comprise a binder, such as a gelling agent, and an aerosol former. Optionally, a substance to be delivered and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be in the form of an aerosol-generating film. The aerosol-generating film may comprise a binder, such as a gelling agent, and an aerosol former. Optionally, a substance to be delivered and/or filler may also be present. The aerosol-generating film may be substantially free from botanical material. In particular, in some embodiments, the aerosol-generating material is substantially tobacco free.

The aerosol-generating film may have a thickness of about 0.015 mm to about 1 mm. For example, the thickness may be in the range of about 0.05 mm, 0.1 mm or 0.15 mm to about 0.5 mm or 0.3 mm.

The aerosol-generating film may be formed by combining a binder, such as a gelling agent, with a solvent, such as water, an aerosol-former and one or more other components, such as one or more substances to be delivered, to form a slurry and then heating the slurry to volatilize at least some of the solvent to form the aerosol-generating film.

The slurry may be heated to remove at least about 60 wt %, 70 wt %, 80 wt %, 85 wt % or 90 wt % of the solvent.

The aerosol-generating material may comprise or be an “amorphous solid”. In some embodiments, the aerosol-generating material comprises an aerosol-generating film that is an amorphous solid. The amorphous solid may be a “monolithic solid”. The amorphous solid may be substantially non-fibrous. In some embodiments, the amorphous solid may be a dried gel. The amorphous solid is a solid material that may retain some fluid, such as liquid, within it. In some embodiments, the amorphous solid may, for example, comprise from about 50 wt %, 60 wt % or 70 wt % of amorphous solid, to about 90 wt %, 95 wt % or 100 wt % of amorphous solid.

The amorphous solid may be substantially free from botanical material. The amorphous solid may be substantially tobacco free.

In an embodiment of any of the above embodiments the aerosol-generating material comprises an active substance.

The active substance as used herein may be a physiologically active material, which is a material intended to achieve or enhance a physiological response. The active substance may for example be selected from nutraceuticals, nootropics, psychoactives. The active substance may be naturally occurring or synthetically obtained. The active substance may comprise for example nicotine, caffeine, taurine, terpenes of non-cannabinoid origin, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

The active substance may comprise one or more constituents, derivatives or extracts of cannabis, such as one or more cannabinoids or terpenes.

In some embodiments, the active substance comprises nicotine. In some embodiments, the active substance comprises caffeine, melatonin or vitamin B12.

The active substance may comprise or be derived from one or more botanicals or constituents, derivatives or extracts thereof. As used herein, the term “botanical” includes any material derived from plants including, but not limited to, extracts, leaves, bark, fibers, stems, roots, seeds, flowers, fruits, pollen, husk, shells or the like. Alternatively, the material may comprise an active compound naturally existing in a botanical, obtained synthetically. The material may be in the form of liquid, gas, solid, powder, dust, crushed particles, granules, pellets, shreds, strips, sheets, or the like. Example botanicals are tobacco, eucalyptus, star anise, hemp, cocoa, cannabis, fennel, lemongrass, peppermint, spearmint, rooibos, chamomile, flax, ginger, Ginkgo biloba, hazel, hibiscus, laurel, licorice (liquorice), matcha, mate, orange skin, papaya, rose, sage, tea such as green tea or black tea, thyme, clove, cinnamon, coffee, aniseed (anise), basil, bay leaves, cardamom, coriander, cumin, nutmeg, oregano, paprika, rosemary, saffron, lavender, lemon peel, mint, juniper, elderflower, vanilla, wintergreen, beefsteak plant, curcuma, turmeric, sandalwood, cilantro, bergamot, orange blossom, myrtle, cassis, valerian, pimento, mace, damien, marjoram, olive, lemon balm, lemon basil, chive, carvi, verbena, tarragon, geranium, mulberry, ginseng, theanine, theacrine, maca, ashwagandha, damiana, guarana, chlorophyll, baobab or any combination thereof. The mint may be chosen from the following mint varieties: Mentha Arventis, Mentha c.v., Mentha niliaca, Mentha piperita, Mentha piperita citrata c.v., Mentha piperita c.v, Mentha spicata crispa, Mentha cardifolia, Memtha longifolia, Mentha suaveolens variegata, Mentha pulegium, Mentha spicata c.v. and Mentha suaveolens

In some embodiments, the active substance comprises or is derived from one or more botanicals or constituents, derivatives or extracts thereof and the botanical is tobacco.

In some embodiments, the active substance comprises or derived from one or more botanicals or constituents, derivatives or extracts thereof and the botanical is selected from eucalyptus, star anise, cocoa and hemp.

In some embodiments, the active substance comprises or derived from one or more botanicals or constituents, derivatives or extracts thereof and the botanical is selected from rooibos and fennel.

In some embodiments, the aerosol-generating material comprises a flavor or flavorant.

As used herein, the terms “flavor” and “flavorant” refer to materials which, where local regulations permit, may be used to create a desired taste, aroma or other somatosensorial sensation in a product for adult consumers. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gas.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor comprises flavor components extracted from cannabis.

In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucolyptol, WS-3.

The aerosol-generating material is a material that is capable of generating aerosol, for example when heated, irradiated or energized in any other way. Aerosol-generating material may, for example, be in the form of a solid, liquid or gel which may or may not contain an active substance and/or flavorants.

The aerosol-generating material comprises an aerosol former.

In some embodiments the aerosol generating agent may comprise one or more constituents capable of forming an aerosol. In some embodiments, the aerosol generating agent may comprise one or more of glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate. In particular examples, the aerosol generating agent comprises glycerol.

In some embodiments, the aerosol generating agent comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some embodiments, the aerosol generating material may comprise from about 0.1 wt %, 0.5 wt %, 1 wt %, 3 wt %, 5 wt %, 7 wt % or 10% to about 50 wt %, 45 wt %, 40 wt %, 35 wt %, 30 wt % or 25 wt % of an aerosol generating agent (all calculated on a dry weight basis). The aerosol generating agent may act as a plasticiser. For example, the aerosol generating material may comprise 0.5-40 wt %, 3-35 wt % or 10-25 wt % of an aerosol generating agent.

In some embodiments, the aerosol generating material may comprise from about 5 wt %, 10 wt %, 20 wt %, 25 wt %, 27 wt % or 30 wt % to about 60 wt %, 55 wt %, 50 wt %, 45 wt %, 40 wt %, or 35 wt % of an aerosol generating agent (DWB). For example, the aerosol generating material may comprise 10-60 wt %, 20-50 wt %, 25-40 wt % or 30-35 wt % of an aerosol generating agent.

In some embodiments, the aerosol generating material may comprise up to about 80 wt %, such as about 40 to 80 wt %, 40 to 75 wt %, 50 to 70 wt %, or 55 to 65 wt % of an aerosol generating agent (DWB).

The aerosol generating material may also comprise a gelling agent. In some embodiments, the gelling agent comprises a hydrocolloid. In some embodiments, the gelling agent comprises one or more compounds selected from the group comprising alginates, pectins, starches (and derivatives), celluloses (and derivatives), gums, silica or silicones compounds, clays, polyvinyl alcohol and combinations thereof. For example, in some embodiments, the gelling agent comprises one or more of alginates, pectins, hydroxyethyl cellulose, hydroxypropyl cellulose, carboxymethylcellulose, pullulan, xanthan gum guar gum, carrageenan, agarose, acacia gum, fumed silica, PDMS, sodium silicate, kaolin and polyvinyl alcohol. In some cases, the gelling agent comprises alginate and/or pectin, and may be combined with a setting agent (such as a calcium source) during formation of the aerosol generating material. In some cases, the aerosol generating material may comprise a calcium-crosslinked alginate and/or a calcium-crosslinked pectin.

In some embodiments, the gelling agent comprises one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

In some embodiments, the gelling agent comprises alginate, and the alginate is present in the aerosol generating material in an amount of from 10-30 wt % of the aerosol generating material (calculated on a dry weight basis). In some embodiments, alginate is the only gelling agent present in the aerosol generating material. In other embodiments, the gelling agent comprises alginate and at least one further gelling agent, such as pectin.

In some embodiments, the aerosol generating material comprises from about 1 wt %, 5 wt %, 10 wt %, 15 wt %, 20 wt % or 25 wt % to about 60 wt %, 50 wt %, 45 wt %, 40 wt % or 35 wt % of a gelling agent (all calculated on a dry weight basis). For example, the aerosol generating material may comprise 1-50 wt %, 5-45 wt %, 10-40 wt % or 20-35 wt % of a gelling agent.

In some embodiments, the aerosol generating material comprises from about 20 wt % 22 wt %, 24 wt % or 25 wt % to about 30 wt %, 32 wt % or 35 wt % of a gelling agent (all calculated on a dry weight basis). For example, the aerosol generating material may comprise 20-35 wt % or 25-30 wt % of a gelling agent.

In some cases, the aerosol generating material may comprise from about 1 wt %, 5 wt %, 10 wt %, 15 wt % or 20 wt % to about 60 wt %, 50 wt %, 40 wt %, 30 wt % or 25 wt % of a gelling agent (DWB). For example, the aerosol generating material may comprise 10-40 wt %, 15-30 wt % or 20-25 wt % of a gelling agent (DWB).

In examples, the aerosol generating material comprises gelling agent and filler, taken together, in an amount of from about 10 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent and filler, taken together, in an amount of from about 20 to 60 wt %, 25 to 55 wt %, 30 to 50 wt %, or 35 to 45 wt % of the aerosol generating material.

In examples, the aerosol generating material comprises gelling agent (i.e. without taking into account the amount of filler) in an amount of from about 5 wt %, 10 wt %, 15 wt %, 20 wt %, 25 wt %, 30 wt %, or 35 wt % to about 60 wt %, 55 wt %, 50 wt %, or 45 wt % of the aerosol generating material. In examples, the aerosol generating material comprises gelling agent (i.e. without taking into account the amount of filler) in an amount of from about 5 to 60 wt %, 20 to 60 wt %, 25 to 55 wt %, 30 to 50 wt %, or 35 to 45 wt % of the aerosol generating material.

In some examples, alginate is comprised in the gelling agent in an amount of from about 5 to 40 wt % of the aerosol generating material, or 15 to 40 wt %. That is, the aerosol generating material comprises alginate in an amount of about 5 to 40 wt % by dry weight of the aerosol generating material, or 15 to 40 wt %. In some examples, the aerosol generating material comprises alginate in an amount of from about 20 to 40 wt %, or about 15 wt % to 35 wt % of the aerosol generating material.

In some examples, pectin is comprised in the gelling agent in an amount of from about 3 to 15 wt % of the aerosol generating material. That is, the aerosol generating material comprises pectin in an amount of from about 3 to 15 wt % by dry weight of the aerosol generating material. In some examples, the aerosol generating material comprises pectin in an amount of from about 5 to 10 wt % of the aerosol generating material.

In some examples, guar gum is comprised in the gelling agent in an amount of from about 3 to 40 wt % of the aerosol generating material. That is, the aerosol generating material comprises guar gum in an amount of from about 3 to 40 wt % by dry weight of the aerosol generating material. In some examples, the aerosol generating material comprises guar gum in an amount of from about 5 to 10 wt % of the aerosol generating material. In some examples, the aerosol generating material comprises guar gum in an amount of from about 15 to 40 wt % of the aerosol generating material, or from about 20 to 40 wt %, or from about 15 to 35 wt %.

In examples, the alginate is present in an amount of at least about 50 wt % of the gelling agent. In examples, the aerosol generating material comprises alginate and pectin, and the ratio of the alginate to the pectin is from 1:1 to 10:1. The ratio of the alginate to the pectin is typically >1:1, i.e. the alginate is present in an amount greater than the amount of pectin. In examples, the ratio of alginate to pectin is from about 2:1 to 8:1, or about 3:1 to 6:1, or is approximately 4:1.

The aerosol generating material may be formed by (a) forming a slurry comprising components of the aerosol generating material or precursors thereof, (b) forming a layer of the slurry, (c) setting the slurry to form a gel, and (d) drying to form an aerosol generating material.

The (b) forming a layer of the slurry typically comprises spraying, casting or extruding the slurry. In examples, the slurry layer is formed by electrospraying the slurry. In examples, the slurry layer is formed by casting the slurry.

In some examples, (b) and/or (c) and/or (d), at least partially, occur simultaneously (for example, during electrospraying). In some examples, (b), (c) and (d) occur sequentially.

In some examples, the slurry is applied to a support. The layer may be formed on a support.

In examples, the slurry comprises gelling agent, aerosol-former material and active substance. The slurry may comprise these components in any of the proportions given herein in relation to the composition of the aerosol generating material. For example, the slurry may comprise (on a dry weight basis):
gelling agent and, optionally, filler, wherein the amount of gelling agent and filler taken together is about 10 to 60 wt % of the slurry;
aerosol-former material in an amount of about 40 to 80 wt % of the slurry; and
optionally, active substance in an amount of up to about 20 wt % of the slurry.

The setting the gel (c) may comprise supplying a setting agent to the slurry. For example, the slurry may comprise sodium, potassium or ammonium alginate as a gel-precursor, and a setting agent comprising a calcium source (such as calcium chloride), may be added to the slurry to form a calcium alginate gel.

In examples, the setting agent comprises or consists of calcium acetate, calcium formate, calcium carbonate, calcium hydrogencarbonate, calcium chloride, calcium lactate, or a combination thereof. In some examples, the setting agent comprises or consists of calcium formate and/or calcium lactate. In particular examples, the setting agent comprises or consists of calcium formate. The inventors have identified that, typically, employing calcium formate as a setting agent results in an aerosol generating material having a greater tensile strength and greater resistance to elongation.

The total amount of the setting agent, such as a calcium source, may be 0.5-5 wt % (calculated on a dry weight basis). Suitably, the total amount may be from about 1 wt %, 2.5 wt % or 4 wt % to about 4.8 wt % or 4.5 wt %. The inventors have found that the addition of too little setting agent may result in an aerosol generating material which does not stabilise the aerosol generating material components and results in these components dropping out of the aerosol generating material. The inventors have found that the addition of too much setting agent results in an aerosol generating material that is very tacky and consequently has poor handleability.

When the aerosol generating material does not contain tobacco, a higher amount of setting agent may need to be applied. In some cases the total amount of setting agent may therefore be from 0.5-12 wt % such as 5-10 wt %, calculated on a dry weight basis. Suitably, the total amount may be from about 5 wt %, 6 wt % or 7 wt % to about 12 wt % or 10 wt %. In this case the aerosol generating material will not generally contain any tobacco.

In examples, supplying the setting agent to the slurry comprises spraying the setting agent on the slurry, such as a top surface of the slurry.

Alginate salts are derivatives of alginic acid and are typically high molecular weight polymers (10-600 kDa). Alginic acid is a copolymer of β-D-mannuronic (M) and α-L-guluronic acid (G) units (blocks) linked together with (1,4)-glycosidic bonds to form a polysaccharide. On addition of calcium cations, the alginate crosslinks to form a gel. It has been found that alginate salts with a high G monomer content more readily form a gel on addition of the calcium source. In some cases therefore, the gel-precursor may comprise an alginate salt in which at least about 40%, 45%, 50%, 55%, 60% or 70% of the monomer units in the alginate copolymer are α-L-guluronic acid (G) units.

In examples, the drying (d) removes from about 50 wt %, 60 wt %, 70 wt %, 80 wt % or 90 wt % to about 80 wt %, 90 wt % or 95 wt % (WWB) of water in the slurry.

In examples, the drying (d) reduces the cast material thickness by at least 80%, suitably 85% or 87%. For instance, the slurry is cast at a thickness of 2 mm, and the resulting dried aerosol generating material has a thickness of 0.2 mm.

In some examples, the slurry solvent consists essentially of or consists of water. In some examples, the slurry comprises from about 50 wt %, 60 wt %, 70 wt %, 80 wt % or 90 wt % of solvent (WWB).

In examples where the solvent consists of water, the dry weight content of the slurry may match the dry weight content of the aerosol generating material. Thus, the discussion herein relating to the solid composition is explicitly disclosed in combination with the slurry aspect of the invention.

The aerosol generating material may comprises a flavor. Suitably, the aerosol generating material may comprise up to about 80 wt %, 70 wt %, 60 wt %, 55 wt %, 50 wt % or 45 wt % of a flavor. In some cases, the aerosol generating material may comprise at least about 0.1 wt %, 1 wt %, 10 wt %, 20 wt %, 30 wt %, 35 wt % or 40 wt % of a flavor (all calculated on a dry weight basis). For example, the aerosol generating material may comprise 1-80 wt %, 10-80 wt %, 20-70 wt %, 30-60 wt %, 35-55 wt % or 30-45 wt % of a flavor. In some cases, the flavor comprises, consists essentially of or consists of menthol.

The aerosol generating material may comprises a filler.

In some embodiments, the aerosol generating material comprises less than 60 wt % of a filler, such as from 1 wt % to 60 wt %, or 5 wt % to 50 wt %, or 5 wt % to 30 wt %, or 10 wt % to 20 wt %.

In other embodiments, the aerosol generating material comprises less than 20 wt %, suitably less than 10 wt % or less than 5 wt % of a filler. In some cases, the aerosol generating material comprises less than 1 wt % of a filler, and in some cases, comprises no filler.

In some such cases the aerosol generating material comprises at least 1 wt % of the filler, for example, at least 5 wt %, at least 10 wt %, at least 20 wt % at least 30 wt %, at least 40 wt %, or at least 50 wt % of the filler. In some embodiments, the aerosol generating material comprises 5-25 wt % of the filler.

The filler, if present, may comprise one or more inorganic filler materials, such as calcium carbonate, perlite, vermiculite, diatomaceous earth, colloidal silica, magnesium oxide, magnesium sulphate, magnesium carbonate, and suitable inorganic sorbents, such as molecular sieves. The filler may comprise one or more organic filler materials such as wood pulp, cellulose and cellulose derivatives (such as methylcellulose, hydroxypropyl cellulose, and carboxymethyl cellulose (CMC)). In particular cases, the aerosol generating material comprises no calcium carbonate such as chalk.

In particular embodiments which include filler, the filler is fibrous. For example, the filler may be a fibrous organic filler material such as wood pulp, hemp fiber, cellulose or cellulose derivatives (such as methylcellulose, hydroxypropyl cellulose, and carboxymethyl cellulose (CMC)).

Without wishing to be bound by theory, it is believed that including fibrous filler in an aerosol generating material may increase the tensile strength of the material. This may be particularly advantageous in examples wherein the aerosol generating material is provided as a sheet, such as when an aerosol generating material sheet circumscribes a rod of aerosolizable material.

In some embodiments, the aerosol generating material does not comprise tobacco fibers. In particular embodiments, the aerosol generating material does not comprise fibrous material.

The aerosol-generating material may comprise one or more active substances and/or flavors, one or more aerosol-former materials, and optionally one or more other functional material.

In some embodiments, the aerosol generating material additionally comprises an active substance. For example, in some cases, the aerosol generating material additionally comprises a tobacco material and/or nicotine. In some embodiments, the aerosol generating material comprises powdered tobacco and/or nicotine and/or a tobacco extract.

In some cases, the aerosol generating material may comprise 5-60 wt % (calculated on a dry weight basis) of a tobacco material and/or nicotine. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of an active substance. In some cases, the aerosol generating material may comprise from about 1 wt %, 5 wt %, 10 wt %, 15 wt %, 20 wt % or 25 wt % to about 70 wt %, 60 wt %, 50 wt %, 45 wt %, 40 wt %, 35 wt %, or 30 wt % (calculated on a dry weight basis) of a tobacco material. For example, the aerosol generating material may comprise 10-50 wt %, 15-40 wt % or 20-35 wt % of a tobacco material. In some cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the aerosol generating material comprises an active substance such as tobacco extract. In some cases, the aerosol generating material may comprise 5-60 wt % (calculated on a dry weight basis) of tobacco extract. In some cases, the aerosol generating material may comprise from about 5 wt %, 10 wt %, 15 wt %, 20 wt % or 25 wt % to about 60 wt %, 50 wt %, 45 wt %, 40 wt %, 35 wt %, or 30 wt % (calculated on a dry weight basis) tobacco extract. For example, the aerosol generating material may comprise 10-50 wt %, 15-40 wt % or 20-35 wt % of tobacco extract. The tobacco extract may contain nicotine at a concentration such that the aerosol generating material comprises 1 wt % 1.5 wt %, 2 wt % or 2.5 wt % to about 6 wt %, 5 wt %, 4.5 wt % or 4 wt % (calculated on a dry weight basis) of nicotine. In some cases, there may be no nicotine in the aerosol generating material other than that which results from the tobacco extract.

In some embodiments the aerosol generating material comprises no tobacco material but does comprise nicotine. In some such cases, the aerosol generating material may comprise from about 1 wt %, 2 wt %, 3 wt % or 4 wt % to about 20 wt %, 18 wt %, 15 wt % or 12 wt % (calculated on a dry weight basis) of nicotine. For example, the aerosol generating material may comprise 1-20 wt %, 2-18 wt % or 3-12 wt % of nicotine.

In some cases, the total content of active substance and/or flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

In some cases, the total content of tobacco material, nicotine and flavor may be at least about 0.1 wt %, 1 wt %, 5 wt %, 10 wt %, 20 wt %, 25 wt % or 30 wt %. In some cases, the total content of active substance and/or flavor may be less than about 90 wt %, 80 wt %, 70 wt %, 60 wt %, 50 wt % or 40 wt % (all calculated on a dry weight basis).

The aerosol-generating composition may comprise one or more active substances. In examples, the aerosol generating material comprises one or more active substances, e.g. up to about 20 wt % of the aerosol generating material. In examples, the aerosol generating material comprises active substance in an amount of from about 1 wt %, 5 wt %, 10 wt %, or 15 wt % to about 20 wt %, 15 wt %, 15 wt % or 5 wt % of the aerosol generating material.

The active substance may comprise a physiologically and/or olfactory active substance which is included in the aerosol-generating composition in order to achieve a physiological and/or olfactory response.

Tobacco material may be present in the aerosol-generating composition in an amount of from about 50 to 95 wt %, or about 60 to 90 wt %, or about 70 to 90 wt %, or about 75 to 85 wt %.

The tobacco material may be present in any format, but is typically fine-cut (e.g. cut into narrow shreds). Fine-cut tobacco material may advantageously be blended with the aerosol generating material to provide an aerosol-generating composition which has an even dispersion of tobacco material and aerosol generating material throughout the aerosol-generating composition.

In examples, the tobacco material comprises one or more of ground tobacco, tobacco fiber, cut tobacco, extruded tobacco, tobacco stem, reconstituted tobacco and/or tobacco extract. Surprisingly, the inventors have identified that it is possible to use a relatively large amount of lamina tobacco in the aerosol-generating composition and still provide an acceptable aerosol when heated by a non-combustible aerosol provision system. Lamina tobacco typically provides superior sensory characteristics. In examples, the tobacco material comprises lamina tobacco in an amount of at least about 50 wt %, 60 wt %, 70 wt %, 80 wt %, 85 wt %, 90 wt %, or 95 wt % of the tobacco material. In particular examples, the tobacco material comprises cut tobacco in an amount of at least about 50 wt %, 60 wt %, 70 wt %, 80 wt %, 85 wt %, 90 wt %, or 95 wt % of the tobacco material.

The tobacco used to produce tobacco material may be any suitable tobacco, such as single grades or blends, cut rag or whole leaf, including Virginia and/or Burley and/or Oriental.

In some embodiments the one or more other functional materials may comprise one or more of pH regulators, coloring agents, preservatives, binders, fillers, stabilizers, and/or antioxidants.

In some cases, the aerosol generating material may additionally comprise an emulsifying agent, which emulsified molten flavor during manufacture. For example, the aerosol generating material may comprise from about 5 wt % to about 15 wt % of an emulsifying agent (calculated on a dry weight basis), suitably about 10 wt %. The emulsifying agent may comprise acacia gum.

In some embodiments, the aerosol generating material is a hydrogel and comprises less than about 20 wt % of water calculated on a wet weight basis. In some cases, the hydrogel may comprise less than about 15 wt %, 12 wt % or 10 wt % of water calculated on a wet weight basis. In some cases, the hydrogel may comprise at least about 1 wt %, 2 wt % or at least about 5 wt % of water (WWB).

The aerosol generating material may have any suitable water content, such as from 1 wt % to 15 wt %. Suitably, the water content of the aerosol generating material is from about 5 wt %, 7 wt % or 9 wt % to about 15 wt %, 13 wt % or 11 wt % (WWB), most suitably about 10 wt % . . . . The water content of the aerosol generating material may, for example, be determined by Karl-Fischer-titration or Gas Chromatography with Thermal Conductivity Detector (GC-TCD).

In some cases, the aerosol generating material may consist essentially of, or consist of a gelling agent, water, an aerosol generating agent, a flavor, and optionally an active substance.

In some cases, the aerosol generating material may consist essentially of, or consist of a gelling agent, water, an aerosol generating agent, a flavor, and optionally a tobacco material and/or a nicotine source.

In examples, the aerosol generating material consists essentially of, or consists of a gelling agent, aerosol generating agent, active substance, and water. In examples, the aerosol generating material consists essentially of, or consists of a gelling agent, aerosol generating agent, and water.

In examples, the aerosol generating material does not comprise a flavorant; in particular examples, the aerosol generating material does not comprise an active substance.

In some embodiments the aerosol generating material comprises:
1-60 wt % of a gelling agent;
0.1-50 wt % of an aerosol generating agent; and
0.1-80 wt % of a flavor;
   wherein these weights are calculated on a dry weight basis

In some embodiments, the aerosol generating material comprises 1-80 wt % of a flavor (dry weight basis).

In some embodiments, the aerosol generating material comprising:
1-50 wt % of a gelling agent;
0.1-50 wt % of an aerosol generating agent; and
30-60 wt % of a flavor;
   wherein these weights are calculated on a dry weight basis.

In alternative embodiments of the aerosol generating material, the aerosol generating material comprises:
1-60 wt % of a gelling agent;
5-60 wt % of an aerosol generating agent; and
10-60 wt % of a tobacco extract;
   wherein these weights are calculated on a dry weight basis.

In some embodiments, the aerosol generating material comprises:
1-60 wt % of a gelling agent;
20-60 wt % of an aerosol generating agent; and
10-60 wt % of a tobacco extract;
   wherein these weights are calculated on a dry weight basis.

In some embodiments, the aerosol generating material comprises 20-35 wt % of the gelling agent; 10-25 wt % of the aerosol-former material; 5-25 wt % of the filler comprising fibers; and 35-50 wt % of the flavorant and/or active substance.

In some cases, the aerosol generating material may consist essentially of, or consist of a gelling agent, an aerosol generating agent a tobacco extract, water, and optionally a flavor. In some cases, the aerosol generating material may consist essentially of, or consist of glycerol, alginates and/or pectins, a tobacco extract and water.

In some embodiments, the aerosol generating material may have the following composition (DWB): gelling agent (preferably comprising alginate) in an amount of from about 5 wt % to about 40 wt %, or about 10 wt % to 30 wt %, or about 15 wt % to about 25 wt %; tobacco extract in an amount of from about 30 wt % to about 60 wt %, or from about 40 wt % to 55 wt %, or from about 45 wt % to about 50 wt %; aerosol generating agent (preferably comprising glycerol) in an amount of from about 10 wt % to about 50 wt %, or from about 20 wt % to about 40 wt %, or from about 25 wt % to about 35 wt % (DWB).

In one embodiment, the aerosol generating material comprises about 20 wt % alginate gelling agent, about 48 wt % Virginia tobacco extract and about 32 wt % glycerol (DWB).

The “thickness” of the aerosol generating material describes the shortest distance between a first surface and a second surface. In embodiments where the aerosol generating material is in the form of a sheet, the thickness of the aerosol generating material is the shortest distance between a first planar surface of the sheet and a second planar surface of the sheet which opposes the first planar surface of the sheet.

In some cases, the aerosol-forming aerosol generating material layer has a thickness of about 0.015 mm to about 1.5 mm, suitably about 0.05 mm to about 1.5 mm or 0.05 mm to about 1.0 mm. Suitably, the thickness may be in the range of from about 0.1 mm or 0.15 mm to about 1.0 mm, 0.5 mm or 0.3 mm.

In some cases, the aerosol generating material may have a thickness of about 0.015 mm to about 1.0 mm. Suitably, the thickness may be in the range of about 0.05 mm, 0.1 mm or 0.15 mm to about 0.5 mm or 0.3 mm.

A material having a thickness of 0.2 mm is particularly suitable. The aerosol generating material may comprise more than one layer, and the thickness described herein refers to the aggregate thickness of those layers.

It has been found that if the aerosol-generating material is too thick, then heating efficiency is compromised. This adversely affects the power consumption in use. Conversely, if the aerosol-generating material is too thin, it is difficult to manufacture and handle; a very thin material is harder to cast and may be fragile, compromising aerosol formation in use.

The thickness stipulated herein is a mean thickness for the material. In some cases, the aerosol generating material thickness may vary by no more than 25%, 20%, 15%, 10%, 5% or 1%.

In some examples, the aerosol generating material in sheet form may have a tensile strength of from around 200 N/m to around 900 N/m. In some examples, such as where the aerosol generating material does not comprise a filler, the aerosol generating material may have a tensile strength of from 200 N/m to 400 N/m, or 200 N/m to 300 N/m, or about 250 N/m.

Such tensile strengths may be particularly suitable for embodiments wherein the aerosol generating material is formed as a sheet and then shredded and incorporated into an aerosol generating article. In some examples, such as where the aerosol generating material comprises a filler, the aerosol generating material may have a tensile strength of from 600 N/m to 900 N/m, or from 700 N/m to 900 N/m, or around 800 N/m. Such tensile strengths may be particularly suitable for embodiments wherein the aerosol generating material is included in an aerosol generating article/assembly as a rolled sheet, suitably in the form of a tube.

In some examples, the aerosol generating material in sheet form may have a tensile strength of from around 200 N/m to around 2600 N/m. In some examples, the aerosol generating material may have a tensile strength of from 600 N/m to 2000 N/m, or from 700 N/m to 1500 N/m, or around 1000 N/m. Such tensile strengths may be particularly suitable for embodiments wherein the aerosol-generating material is formed and incorporated into an aerosol-generating consumable as a sheet.

The aerosol generating material may have any suitable area density, such as from 30 g/m² to 120 g/m². In some cases, the sheet may have a mass per unit area of 80-120 g/m², or from about 70 to 110 g/m², or particularly from about 90 to 110 g/m², or suitably about 100 g/m² (so that it has a similar density to cut rag tobacco and a mixture of these substances will not readily separate). In some cases, the sheet may have a mass per unit area of about 30 to 70 g/m², 40 to 60 g/m², or 25-60 g/m² and may be used to wrap an aerosolizable material such as tobacco.

All percentages by weight described herein (denoted wt %) are calculated on a dry weight basis, unless explicitly stated otherwise. All weight ratios are also calculated on a dry weight basis. A weight quoted on a dry weight basis refers to the whole of the extract or slurry or material, other than the water, and may include components which by themselves are liquid at room temperature and pressure, such as glycerol. Conversely, a weight percentage quoted on a wet weight basis refers to all components, including water.

The aerosol generating material may comprise a colorant. The addition of a colorant may alter the visual appearance of the aerosol generating material. The presence of colorant in the aerosol generating material may enhance the visual appearance of the aerosol-generating material. By adding a colorant to the aerosol generating material, the aerosol generating material may be color-matched to other components of an article comprising the aerosol generating material.

A variety of colorants may be used depending on the desired color of the aerosol generating material. The color of aerosol generating material may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the aerosol generating material with a brown appearance. In such embodiments, the color of the aerosol generating material may be similar to the color of other components (such as tobacco material) in an aerosol-generating material.

The colorant may be incorporated during the formation of the aerosol generating material (e.g. when forming a slurry comprising the materials that form the aerosol generating material) or it may be applied to the aerosol generating material after its formation (e.g. by spraying it onto the aerosol generating material).

In some embodiments of any of the above embodiments, talcum powder, calcium carbonate powder or other powder is applied to the exposed surface of at least one discrete portion of aerosol-generating material. This may reduce the level of tackiness or adhesion of the aerosol-generating material.

In the following discussions of the accompanying drawings, where the same element is present in a more than one embodiment the same reference numeral is used for that element throughout, where there are similar elements similar reference numerals (the same numeral plus a multiple of 100) are used.

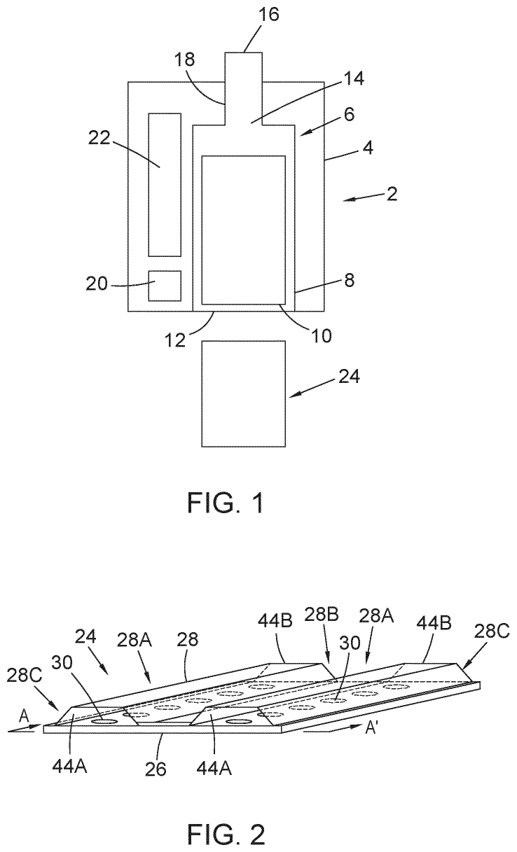

With reference to FIG. 1, an aerosol provision device 2 comprises a casing 4 within which is located a heater assembly 6. The heater assembly 6 is comprised of a heating chamber 8 and an aerosol generator 10. The aerosol generator 10 may be an electrical resistance heater or a magnetic field generator for use with a susceptor.

The heating chamber 8 defines an opening or mouth 12 at a first end of the heating chamber 8. At the opposite end of the heating chamber 8 is an aperture 14. The aperture 14 is in fluid communication with a mouth piece 16 via a conduit 18.

Also located within the casing 4 is a controller 20 which is in electronic communication with and controls the functioning of the aerosol generator 10. The controller 20 may include a memory (not shown) within which one or more tables relating to the operation of the heater 10 may be stored. The aerosol generator 10 and controller 20 are powered by a power source 22. The power source 22 is a rechargeable battery. In other embodiments the power source may be other appropriate sources of electrical power.

The aerosol provision device 2 is suitable for use with a consumable 24. The consumable 24 and heating chamber 8 are so dimensioned and configured that at least a portion of the consumable 24 may be reversibly inserted into the heating chamber 8. The consumable 24 comprises of one or more discrete portions of aerosol generating material. When the consumable 24 is inserted into the heating chamber 8 to the extent required by the design of the heating device 2 and consumable 24 one or more of the discrete portions of the aerosol generating material may be heated by the aerosol generator 10. Although the consumable 24 and heating chamber 8 are shown as rectangular in FIG. 1, they may be of other shapes and configurations.

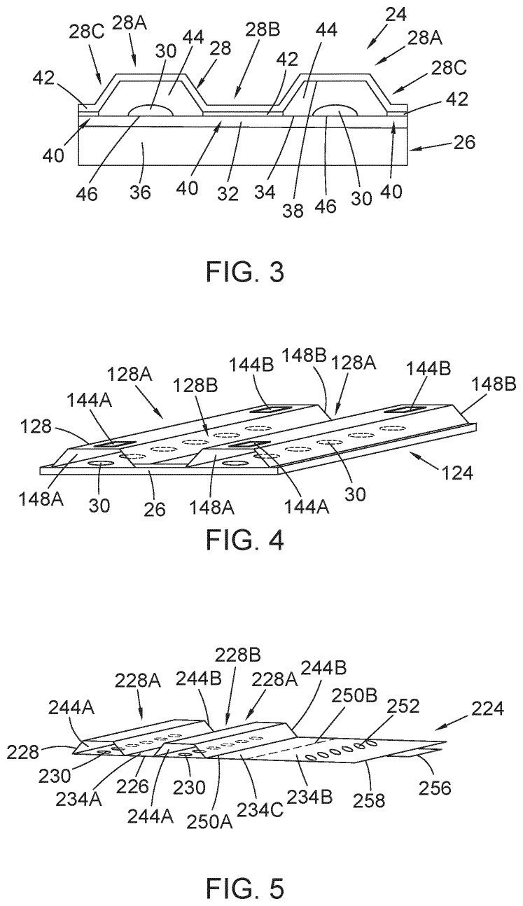

With reference to FIGS. 2 and 3, the consumable 24 includes a support 26, a cover 28 and a plurality of discrete portions of aerosol generating material in the form of an aerosol generating film 30.

The support 26 is a laminate and comprises a first layer 32 and a second layer 36. The first layer 32 is comprised of aluminium foil and all or part of the first layer may act as a susceptor when all or part of the first layer is exposed to an alternating magnetic field.

The second layer 36 of the support 26 is comprised of card.

The first layer 32 is substantially flat or planar and has first and second major surfaces which form the two largest surfaces of the layer 32. The first major surface faces away from the second layer 36 of the support 26 and functions as a support surface 34. The second layer 36 is fixed to the second major surface of the first layer 32 using an adhesive (not shown).

The support surface 34 is, in the example illustrated in FIGS. 2 and 3, adapted to be wholly covered by the cover 28 and thus the covered portion of the support surface 34 is all of the support surface 34. In other non-illustrated examples, less than all of the support surface forms the covered portion of the support surface.

The cover 28 overlies the support surface 34 and has a cover surface 38 which faces towards the support surface 34. The cover 28 is a sheet material and has been embossed to have a three dimensional configuration. The embossing introduced into the cover 28 two parallel linear ridges 28A, one groove 28B and two partial grooves 28C. The shape of the ridges and grooves 28A, 28B is trapezoidal. In other non-illustrated examples the cover may form more ridges and grooves 28A, 28B and the shape of the ridges and grooves may be different shapes, for example, but without limitation, sinusoidal, rectangular or triangular.

When the cover 28 overlies the support surface 34 at least part of the cover surface 38 of each trough 28B or partial trough 28C is in contact with (that is touching or in close proximity to) the support surface 34. The zones where the cover surface 38 and support surface 34 are in contact are contact zones 40. In each contact zone 40 the cover surface 38 is fixed to the support surface 34 by an adhesive 42.

When the cover 28 overlies the support surface 34, the cover surface 38 of the ridges 28A, those parts of the of the cover surface 38 of the trough 28B that are not in contact with the support surface 34, and those parts of the support surface 34 which are not in contact with the cover 28 collectively define a pair of passages 44. The passages 44 are separated from each other by a contact zone 40, and by virtue of the parallel and linear nature of the ridges 28A the passages 44 are parallel and linear. Each passage 44 has a first end 44A and a second end 44B. The first and second ends 44A, 44B of the passages 44 are each defined by portions of the edge or perimeter of the cover 28 and of the support 26.

Spaced along each of the passages 44 are a plurality of discrete portions of aerosol generating film 30. Those portions of aerosol generating film 30 are located at portion locations 46 on the support surface 34. The configuration of the troughs and ridges 28B, 28A of the cover 28 is such that the discrete portions of aerosol generating film 30 are not in contact with the cover surface 38.

When the consumable 24 is in use in an aerosol generating device 2 with an aerosol generator 10 in the form of a magnetic field generator, the aerosol generator 10 causes the foil of the first layer 32 at one or more portion locations 46 to heat. The aerosol generating film 30 at the heated portion locations 46 is thus heated and generates aerosol. When the user of the device 2 draws on the mouthpiece 16 air is drawn along at least one of the passages 44 from one end 44A or 44B to the other end 44B or 44A and the aerosol from the heated aerosol generating film 30 is drawn to the mouthpiece 16.

With reference to FIG. 4, a consumable 124 is shown. The consumable 124 has a support 26 of the same construction and layout as the support 26 of consumable 24 of FIGS. 2 and 3.

The cover 128 overlies the support surface (not shown in FIG. 4) and has a cover surface (not shown in FIG. 4) which faces towards the support surface. The cover 128 is a sheet material and has been folded to have a three dimensional configuration. The folding of the cover 128 created two parallel linear ridges 128A, one groove 128B, and two partial grooves 128C. The shape of the ridges and grooves 128A, 128B is trapezoidal.

When the cover 128 overlies the support surface at least part of the cover surface of each trough 128B or partial trough 128C is in contact with (that is touching or in close proximity to) the support surface. The zones where the cover surface and support surface are in contact are contact zones (not shown in FIG. 4). In each contact zone the cover surface is fixed to the support surface by at least partial melting of the cover 128 and the fusing of the melted portion of the cover 128 with the cover surface before the melted portion of the cover 128 solidifies. In other, non-illustrated examples of consumables of the present disclosure the support 26 and cover 128 are joined in the contact zone by one or more mechanical fixing means, for example staples (where a staple is a short thin piece of wire that is pushed through the cover and support and then bent flat).

When the cover 128 overlies the support surface, the cover surface of the ridges 128A, those parts of the of the cover surface of the trough 128B that are not in contact with the support surface, and those parts of the support surface which are not in contact with the cover 128 collectively define a pair of passages (not shown in FIG. 4). The passages are separated from each other by a contact zone, and by virtue of the parallel and linear nature of the ridges 128A the passages are parallel and linear. The ends of the ridges 128A are closed by end plates 148A, 148B and passage ends 144A, 144B are formed by apertures that extend through the cover 128 adjacent to the end plates 148A, 148B. Such an arrangement allows for a different management of airflow through the consumable 124 and/or the aerosol generating device 2.

Spaced along each of the passages are a plurality of discrete portions of aerosol generating film 30. Those portions of aerosol generating film 30 are located at portion locations (not shown in FIG. 4) on the support surface. The configuration of the troughs and ridges 128B, 128A of the cover 128 is such that the discrete portions of aerosol generating film 30 are not in contact with the cover surface.

With reference to FIGS. 5, 6 and 7, FIG. 5 shows a partially formed consumable 224 which includes a support 226, a cover 228 and a plurality of discrete portions of aerosol generating film 230, 252.

The support 226 is a laminate and comprises a first layer 232 and a second layer 236. The first layer 232 is comprised of aluminium foil and all or part of the first layer may act as a susceptor when all or part of the first layer is exposed to an alternating magnetic field. The second layer 236 of the support 226 is comprised of card.

The first layer 232 is substantially flat or planar and has first and second major surfaces which form the two largest surfaces of the layer 232. The first major surface faces away from the second layer 236 of the support 226 and functions as a support surface 234. The second layer 236 is fixed to the second major surface of the first layer 232 using an adhesive (not shown).

The support surface 234 comprises a covered portion 234A, a second portion 234B and a hinge portion 234C which lies between the covered and second portions 234A, 234B. The covered and second portions 234A, 234B are joined to the hinge portion 234C by first and second fold lines 250A, 250B.

The covered portion 234A of the support surface 234 is adapted to be wholly covered by the cover 228.

The cover 228 overlies the covered portion 234A of the support surface 234 and has a first cover surface 238 which faces towards the covered portion 234A of the support surface 234. The cover 228 also has a second cover surface 254 which faces in the opposite direction to the first cover surface 238. The cover 228 is a sheet material which has been molded to have a three dimensional configuration. The molding formed two parallel linear ridges 228A, one groove 228B and two partial grooves 228C. The shape of the ridges and grooves 228A, 228B is trapezoidal.

When the cover 228 overlies the covered portion of the support surface 234A at least part of the cover surface 238 of each trough 228B or partial trough 228C is in contact with (that is touching or in close proximity to) the covered portion of the support surface 234A. The zones where the first cover surface 238 and the covered portion of the support surface 234A are in contact are contact zones 240. In each contact zone 240 the first cover surface 238 is fixed to the covered portion of the support surface 234A by an adhesive 42.

When the cover 228 overlies the covered portion of the support surface 234A, the first cover surface 238 of the ridges 228A, those parts of the of the first cover surface 238 of the trough 228B that are not in contact with the first portion of the support surface 234A, and those parts of the covered portion of the support surface 234A which are not in contact with the cover 228 collectively define a pair of passages 244. The passages 244 are separated from each other by a contact zone 240, and by virtue of the parallel and linear nature of the ridges 228A the passages 244 are parallel and linear. Each passage 244 has a first end 244A and a second end 244B. The first and second ends 244A, 244B of the passages 244 are each defined by portions of the edge or perimeter of the cover 228 and of the support 226.

Spaced along each of the passages 244 are a plurality of discrete portions of aerosol generating film 230. Those portions of aerosol generating film 230 are located at portion locations 246 on the first portion of the support surface 234A. The configuration of the troughs and ridges 228B, 228A of the cover 228 is such that the discrete portions of aerosol generating film 230 are not in contact with the first cover surface 238.

The second portion 234B of the support surface 234 is substantially flat and supports a plurality of discrete portions of aerosol generating film 252 located at second location positions 260. A catch member 256 extends from the edge 258 of the support 236.

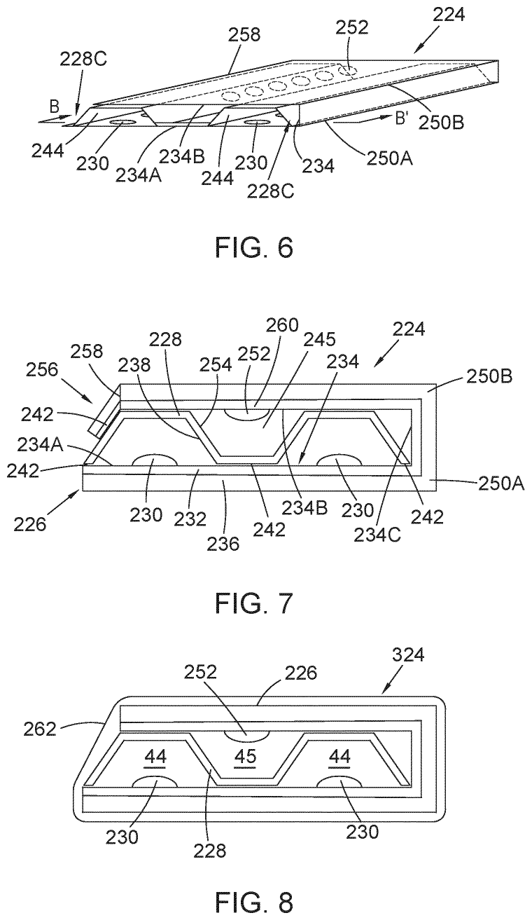

To form the support 226 into the required configuration for the use of the consumable 224 (shown FIGS. 6 and 7) the support 226 is folded about each of the fold lines 250A, 250B by about 90 degrees. This causes the second portion 234B of the support surface 234 to overlie the cover 228 and to contact or lie adjacent to the portions of the second cover surface 254 that form part of the ridges 228A of the cover 228.

The second cover surface 254 of the trough 228B, those parts of the second cover surface 228 of ridges 228A which are not in contact with or adjacent to the second portion 234B of the support surface 234, and a portion of the second portion 234B of the support surface 234 collectively define a passage 245. The passage 245 is linear and parallel to the passages 244 and has first and second ends 245A, 245B.

To hold the support 226 in the folded configuration, the catch member 256 is fixed to the second cover face 254 using an adhesive 242.

The location positions 260 and discrete portions of aerosol generating film 252 are so located on the second portion 234B of the support surface 234 that they are within the passage 245 and not in contact with the second cover surface 254.

When the consumable 224 is to be used in an aerosol generating device 2 with an aerosol generator 10 in the form of a magnetic field generator, the aerosol generator 10 causes the foil of the first layer 232 at one or more portion locations 246, 260 to heat. The aerosol generating film 230, 252 at the heated portion locations 246, 260 is thus heated and generates aerosol. When the user of the device 2 draws on the mouthpiece 16 air is drawn along at least one of the passages 44, 45 from one end 44A, 45A or 44B, 45B to the other end 44B, 44B or 44A, 45A and the aerosol from the heated aerosol generating material 230, 252 is drawn to the mouthpiece 16.

In an alternative embodiment of consumable 224, and as shown in FIG. 8, in a consumable 324 a wrap 262 extends around the longitudinal extent of the support 226 to hold the support and cover 228 in the configuration shown in FIG. 8. In this embodiment, the catch member 256 of the support 226 and all of the adhesive 242 used in the embodiment illustrated in FIGS. 5 to 7 may be omitted. An advantage of this embodiment is that the wrap 262 may be of a suitably heat resistant film and may protect the support 226, cover 228 and aerosol generation films 230, 252 from physical damage and humidity. In some examples, the wrap 262 closes the ends 244A, 244B, 245A, 245B of the passages 244, 245 when first wrapped around the folded support 226 and cover 228. When the consumable 324 is to be used, portions of the wrap 262 are pierced or removed to open the ends 244A, 244B, 245A, 245B of the passages 244, 245 ready for use. The consumable 324 is then used in the same fashion as is described in connection with consumable 224 above.

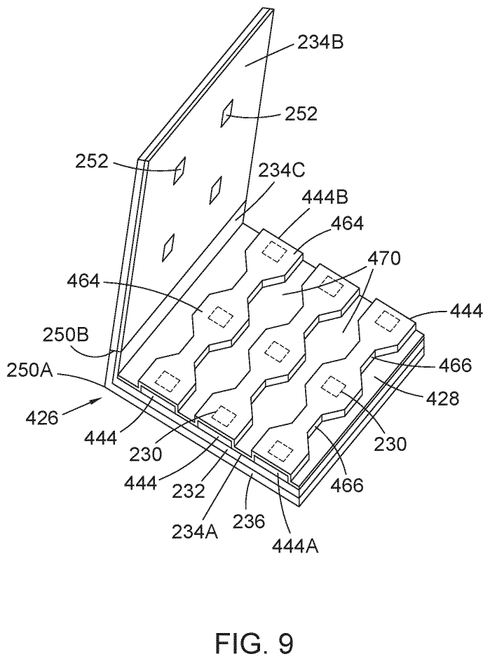

With reference to FIG. 9, an alternative support 426 and cover 428 is shown during the manufacture of a consumable 424. The support 426 is the same as that used in consumable 224 described above with the exception that discrete portions of aerosol generating film 252 are disposed on the second portion 234B of the support surface 234 in grid pattern.

The cover 428 is formed from a blow molded sheet of plastic and, in combination with the first portion of the support surface 234A define three passages 444. Each passage 444 comprises 3 chambers 464 (for clarity not all the chambers 464 are labelled). The centreline of each passage 444 is linear and the centrelines are parallel to each other. In each passage 444 the chambers 446 are joined in series by two conduits 466 (for clarity not all the chambers 464 are labelled). The chambers 464 are larger in at least one direction perpendicular to the centreline of the passage 444 to the than the conduits 466. The discrete portions of aerosol generating film 230 (again, for clarity not all the portions 230 are labelled) are located on the first portion of the support surface 234A so that they are each approximately in the middle of a chamber 464. As previously the passage 444 extends between passage ends 444A and 444B.

The discrete portions of aerosol generating film 252 are located on the second portion 234B of the support surface 234 so that when the second portion 234B of the support surface 234 overlies the cover 428 the discrete portions of aerosol generating film 252 are approximately in the middle of the chambers 470 that are formed between the cover 428 and the second portion of the support surface 234B.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A consumable suitable for use with a non-combustible aerosol provision system, in which the consumable comprises a support, aerosol generating material, and a cover, in which the support comprises a support surface having a covered portion,
the cover comprises a cover surface,
the cover is configured to overlie the covered portion of the support surface,
at least one discrete portion of aerosol generating material is supported on the covered portion of the support surface,
each discrete portion of aerosol generating material supported on the covered portion of the support surface is supported at a portion location,
one or both of the covered portion of the support surface and the cover surface are three dimensionally configured,
the covered portion of the support surface and the cover surface are so configured that at each portion location the cover surface is sufficiently distanced from the covered portion of the support surface that there is no contact between at least part of the discreet portion of aerosol generating material at that portion location and the cover surface,
the covered portion of the support surface and the cover surface are configured to include one or more contact zones, and
in which in each contact zone, a part of the covered portion of the support surface and a part of the cover surface are in direct or indirect contact with each other.

2. A consumable according to claim 1 in which the aerosol generating material is an aerosol generating film.

3. A consumable according to claim 1 in which the covered portion of the support surface and the cover surface are so configured that they define at least one passage, and
at least one passage includes at least one portion location.

4. A consumable according to claim 3 in which each portion location is located in a passage.

5. A consumable according to claim 3 in which the cover surface has a perimeter that extends around the edge of the cover surface, and a first end of at least one passage is open and partially defined by a part of the perimeter of the cover surface.

6. A consumable according to claim 5 in which a second end of at least one passage is open and partially defined by a part of the perimeter of the cover surface.

7. A consumable according to claim 3 in which a first end of at least one passage is open and defined by an aperture extending through one of the covered portion of the support surface or the cover surface.

8. A consumable according to claim 3 in which a second end of at least one passage is open and defined by an aperture extending through one of the covered portion of the support surface or the cover surface.

9. A consumable according to claim 3 in which at least one end of at least one passage is open and opens into another passage.

10. A consumable according to claim 3 in which at least one passage has a non-uniform cross-section along the length of the passage.

11. A consumable according to claim 3 in which there are two or more passages and two of the passages are separated from each other by one contact zone.

12. A consumable according to claim 1 in which each of the passages is separated from the other passages by one or more contact zones.

13. A consumable according to claim 3 in which there are two or more passages and at least two of the passages are approximately parallel to each other.

14. A consumable according to claim 3 in which at least one passage is approximately linear between the first and second ends of that passage.

15. A consumable according to claim 1 in which the covered portion of the support surface and the cover surface are so configured that at at least one portion location, the support surface and the cover surface define one or more chambers, and at least one of the chambers is so configured that in that or those chambers there is no contact between the discreet portion of aerosol generating material and the cover surface.

16. A consumable according to claim 15 in which at least one of the chambers is in fluid contact with at least one of the passages.

17. A consumable according to claim 15 in which at least one end of at least one passage opens into one of the chambers.

18. A consumable according to claim 1 in which at least one of the contact zones is so configured that the part of the covered portion of the support surface and the part of the cover surface in direct or indirect contact with each other in that or those contact zones are fixed to each other using a fixing means.

19. A consumable according to claim 18 in which the fixing means is an adhesive.

20. A consumable according to claim 18 in which the fixing means is a melted and subsequently solidified part of one or both of the support surface and the cover surface.

21. A consumable according to claim 18 in which the fixing means is a physical connection means mounted on or extending through the contact zone.

22. A consumable according to claim 1 in which at least one of the contact zones is so configured that the part of the covered portion of the support surface and the part of the cover surface abut but are not fixed to each other.

23. A consumable according to claim 1 in which the support and the cover are held in a fixed relationship relative to each other by at least one wrapping element wrapped around the support and the cover.

24. A consumable according to claim 1 in which one of the covered portion of the support surface and the cover surface is substantially flat.

25. A consumable according to claim 1 in which the three dimensional configuration of one or both of the covered portion of the support surface and the cover surface is the result of molding moulding one or both of the covered portion of the support and the cover.

26. A consumable according to claim 1 in which the three dimensional configuration of one or both of the covered portion of the support surface and the cover surface is the result of embossing or debossing one or both of the covered portion of the support and the cover.

27. A consumable according to claim 1 in which the three dimensional configuration of one or both of the support surface and the cover surface is the result of folding one or both of the covered portion of the support and the cover.

28. A consumable according to claim 1 in which one or both of the support and the cover is a sheet material.

29. A consumable according to claim 1 in which the support surface further comprises a second portion, the cover further compromises a second cover surface, the support and support surface are so configured that the support can be folded into a folded configuration, and the second portion of the support surface overlies the second cover surface when the support is in the folded configuration.

30. A consumable according to claim 29 in which at least one discrete portion of aerosol generating material is supported on the second portion of the support surface,
each discrete portion of aerosol generating material supported on the second portion of the support surface is supported at a second portion location,
one or both of the second portion of the support surface and the second cover surface are three dimensionally configured,
the second portion of the support surface and the second cover surface are so configured that at each second portion location the second cover surface is sufficiently distanced from the second portion of the support surface that there is no contact between at least part of the discreet portion of aerosol generating material at that second portion location and the second cover surface, the second portion of the support surface and the second cover surface are configured to include one or more second contact zones in which a part of the second portion of the support surface and a part of the second cover surface are in direct or indirect contact with each other.

31. A consumable according to claim 30 in which the second portion of the support surface and the second cover surface are so configured that they define at least one second passage, and
at least one second passage includes at least one second portion location.

32. A consumable according to claim 31 in which each second portion location is located in a second passage.

33. A consumable according to claim 31 in which the second cover surface has a perimeter that extends around the edge of the second cover surface, and a first end of at least one second passage is open and partially defined by a part of the perimeter of the second cover surface.

34. A consumable according to claim 33 in which a second end of the at least one second passage is open and partially defined by a part of the perimeter of the second cover surface.

35. A consumable according to claim 31 in which a first end of at least one second passage is open and defined by an aperture extending through one of the second portion of the support surface or the second cover surface.

36. A consumable according to claim 31 in which a second end of at least one second passage is open and defined by an aperture extending through one of the covered portion of the support surface or the cover surface.

37. A consumable according to claim 31 in which at least one end of at least one second passage is open and opens into another second passage.

38. A consumable according to claim 31 in which at least one end of at least one first passage is open and opens into a second passage.

39. A consumable according to claim 31 to 38 in which at least one end of at least one second passage is open and opens into a first passage.

40. A consumable according to claim 31 in which at least one second passage has a non-uniform cross-section along the length of the second passage.

41. A consumable according to claim 31 in which there are two or more second passages and two of the second passages are separated from each other by one second contact zone.

42. A consumable according to claim 41 in which each of the second passages is separated from other second passages by one or more second contact zones.

43. A consumable according to claim 31 in which there are two or more second passages and at least two of the second passages are approximately parallel to each other.

44. A consumable according to claim 31 in which at least one second passage is approximately linear between the first and second ends of that second passage.

45. A consumable according to claim 30 in which the second portion of the support surface and the second cover surface are so configured that at least one second portion location, the support surface and the second cover surface define one or more chambers, and at least one of the chambers is so configured that in that or those chambers there is no contact between the discreet portion of aerosol generating material and the second cover surface.

46. A consumable according to claim 45 in which at least one of the chambers is in fluid contact with at least one of the second passages.

47. A consumable according to claim 45 in which at least one end of at least one second passage opens into one of the chambers.

48. A consumable according to claim 30 in which at least one of the second contact zones is so configured that the part of the second portion of the support surface and the part of the second cover surface in direct or indirect contact with each other in that or those contact zones are fixed to each other using a fixing means.

49. A consumable according to claim 48 in which the fixing means is an adhesive.

50. A consumable according to claim 48 in which the fixing means is a melted and subsequently solidified part of one or both of the support surface and the second cover surface.

51. A consumable according to claim 48 in which the fixing means is a physical connection means mounted on or extending through the second contact zone.

52. A consumable according to claim 30 in which at least one of the second contact zones is so configured that the support surface and the second cover surface abut but are not fixed to each other.

53. A consumable according to claim 30 in which one of the second portion of the support surface and the second cover surface is substantially flat.

54. A consumable according to claim 30 in which the three dimensional configuration of one or both of the second portion of the support surface and the second cover surface is the result of molding one or both of the second portion of the support and the cover.

55. A consumable according to claim 30 in which the three dimensional configuration of one or both of the second portion of the support surface and the second cover surface is the result of embossing or debossing one or both of the support and the cover.

56. A consumable according to claim 30 in which the three dimensional configuration of one or both of the second portion of the support surface and the second cover surface is the result of folding one or both of the support and the cover.

57. A consumable according to claim 30 in which the support comprises a latching means for retaining the support in the folded configuration.

58. A consumable according to claim 1 in which the support comprises at least one susceptor.

59. A consumable according to claim 1 in which the cover comprises at least one susceptor.

60. A consumable according to claim 58 in which the susceptor is a metallic foil.

61. A consumable according to claim 58 in which one or both of the covered portion of the support surface and the second portion of the support surface comprise a susceptor.

62. A consumable according to claim 1 in which the aerosol generating material is an aerosolisable gel or an aerosol generating film.

63. A consumable according to claim 1 in which there are at least two discrete portions of aerosol generating material and at least two discrete portions of aerosol generating material have different compositions relative to each other.

64. An aerosol provision device for use with a consumable according to claim 1, in which the device comprises an aerosol generator configured to heat at least a portion of the aerosol generating material supported on the consumable.

65. An aerosol provision system comprising a consumable according to claim 1 and an aerosol provision device in which the device comprises an aerosol generator configured to heat at least a portion of the aerosol generation material supported on the consumable.

66. A method of generating aerosol from a consumable according to claim 1 using an aerosol-generating device with at least one aerosol generator disposed to heat, but not burn, the consumable in use; wherein at least one aerosol generator is a resistive heater element or a magnetic field generator and a susceptor.
